(19) United States
(12) Patent Application Publication
(10) Pub. No.: US 2007/0094119 A1
(43) Pub. Date: Apr. 26, 2007

(54) System and method for improving asset liquidity in a trading exchange network

(76) Inventor: Jose Marques, Scarsdale, NY (US)

Correspondence Address: BAKER & BOTTS L.L.P., 30 ROCKEFELLER PLAZA, 44TH FLOOR, NEW YORK, NY, 10112-4498, US

(21) Appl. No.: 11/255,814

(22) Filed: Oct. 21, 2005

(51) Int. Cl. G06Q 40/00

(52) U.S. Cl. 705/36 R

(57) ABSTRACT

Asset liquidity is improved in a transaction network by identifying a potential party to an asset transaction based on an analysis of asset portfolio data. Portfolio data is provided by asset manager clients and transaction proposal data is provided by broker clients. The portfolio data is analyzed in view of the transaction proposal data to determine if at least one predetermined financial threshold would be satisfied in the portfolio by accepting the proposed transaction. An alert message can then be provided to the asset manager client identifying the transaction proposal if a predetermined financial threshold is triggered during the evaluating step.

### FIELD OF THE INVENTION

The present invention relates generally to the trading of stocks or other assets and more particularly relates to a system of improving liquidity in large block transactions of securities by employing portfolio analysis.

### BACKGROUND OF THE INVENTION

Changes in technology over the last decade have vastly improved the ability for an individual or other small retail trader to participate in the trading of stocks. For example, the availability of numerous online information resources and trading facilities has improved the flow of information and has reduced transaction costs for many small to mid-sized stock traders. However, despite the reduced costs enjoyed by retail stock traders, institutional investors which generally participate in large block transactions of a particular security instrument have not enjoyed similar benefits.

To address some of the issues faced by institutional investors, a number of secondary exchange networks have been implemented which allow institutions to participate in large block trades in an anonymous fashion without inducing undesirable market impact that may otherwise result from such transactions taking place on the open market. The advent of the secondary exchange allows institutional investors to post desired buy and sell orders and have these orders matched in an efficient manner. The posting of such block transactions is currently being facilitated by secondary exchange networks, such as the exchange network operating at the Internet domain name www.liquidnet.com. However, to date, such exchanges were only effective if a particular buy order corresponded to a corresponding sell order and vice versa. Without two contra positioned parties simultaneously looking to enter a transaction, the security would not be traded.

It would be desirable to present a system in which a contra position could be identified, based on sound economic principles, for a posted security transaction such that security transactions could be completed more frequently and more efficiently.

### SUMMARY OF THE INVENTION

It is an object of the present invention to provide a method of identifying a contra party for an identified asset transaction.

It is a further object of the present invention to provide a method of identifying a contra party for an identified asset transaction based on an analysis of an existing portfolio of one or more participating parties.

In one embodiment, a method of improving asset liquidity by identifying a potential party to an asset transaction is provided. The method includes receiving portfolio data from an asset manager client and receiving transaction proposal data from a broker client. The method further includes evaluating the portfolio data in view of the transaction proposal data to determine if at least one predetermined financial threshold would be satisfied in the portfolio by accepting the proposed transaction. An alert message can then be provided to the asset manager client identifying the transaction proposal if a predetermined financial threshold is triggered during the evaluating step.

The method can be used with various assets and is particularly beneficial when the asset is a large number of shares of stock.

The transaction proposal can take the form of a buy order or a sell order. In the case of a buy order, the initial step in evaluating the portfolio is identifying those portfolios which own the asset set forth in the transaction proposal.

In an alternate method, portfolio data for a number of portfolios can be analyzed to identify transactions and parties to a transaction that would provide a mutual benefit to two or more portfolios. Such a method would include evaluating first portfolio data and at least a second portfolio data to identify a transaction proposal wherein at least one predetermined financial threshold would be satisfied in each of the first portfolio and second portfolio if the transaction proposal were accepted. If such a transaction is identified, an alert message is then provided to at least one asset manager client identifying the transaction proposal if at least one of said predetermined financial threshold is triggered in said evaluating step. If the transaction is acceptable to the first noticed asset manager client, a second alert message can be transmitted to the other asset manager client to invite participation in the transaction.

A system for asset transactions in accordance with the present invention includes a data network, a server computer operatively coupled to the data network and having a liquidity engine therein, at least one asset manager client computer operatively coupled to said data network with each asset manager client computer providing asset portfolio data for at least one portfolio to said server computer, and at least one broker client computer operatively coupled to the data network for providing transaction proposal data to the server computer. The liquidity engine of the server computer evaluates the portfolio data in view of the transaction proposal data to determine if any predetermined financial thresholds would be satisfied in the portfolio by accepting the proposed transaction. The system can provide an alert message to the asset manager client identifying the transaction proposal if a predetermined financial threshold is triggered during the evaluating step.

In an alternate embodiment of the inventive transaction system, the liquidity engine evaluates first portfolio data and at least a second portfolio data to identify a transaction proposal wherein at least one predetermined financial threshold would be satisfied in both the first portfolio and second portfolio if the transaction proposal were accepted and provides an alert message to at least one asset manager client identifying the transaction proposal if at least one of said predetermined financial threshold is triggered in said evaluating step.

### BRIEF DESCRIPTION OF THE DRAWING

Further objects, features and advantages of the invention will become apparent from the following detailed description taken in conjunction with the accompanying figures showing illustrative embodiments of the invention, in which:

FIG. 1 is a simplified block diagram of a securities exchange system in which portfolio analysis is employed to improve asset liquidity;

FIG. 2 is a flow chart illustrating a method of improving liquidity of block transactions employing portfolio analysis to identify a potential participant to a securities transaction; and

FIG. 3 is a flow chart illustrating an alternative method of improving liquidity of block transactions employing portfolio analysis to identify a potential transaction as well as participants to the potential transaction.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION OF PREFERRED EMBODIMENTS

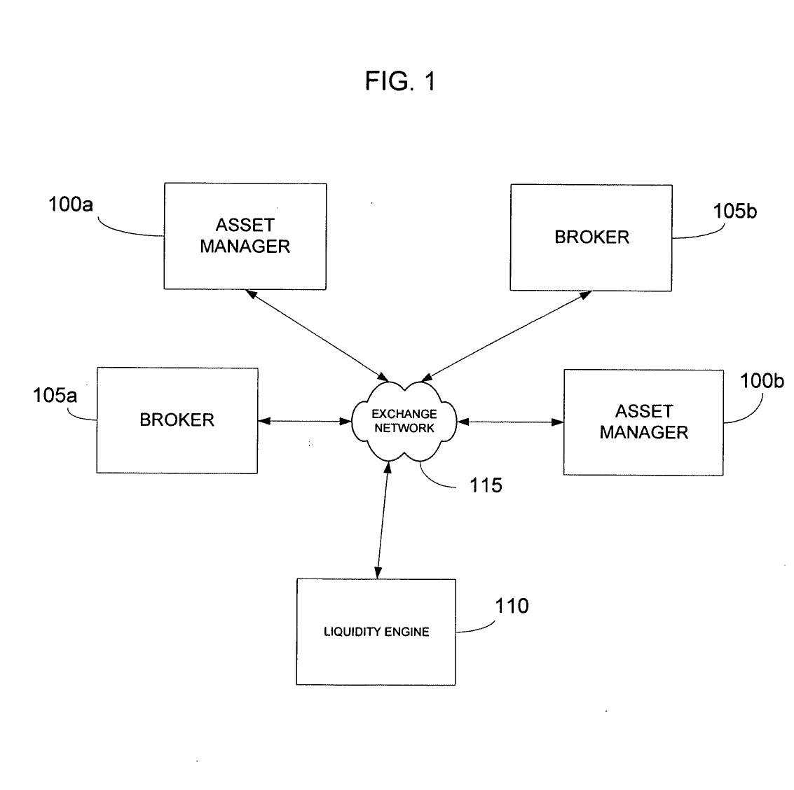

FIG. 1 is a simplified block diagram illustrating the operation of an exchange system in accordance with the present invention. The system involves a number of client's computers including asset manager clients 100a, 100b, and broker clients 105a, 105b. While two asset manager clients and two broker clients are shown for illustrative purposes, it will be appreciated that any arbitrary number of clients of either type can participate in such a system. Indeed, a large number of clients are preferred in order to facilitate a broad, open market place. The various clients are coupled together by a network intermediary, illustrated as exchange network 115. The exchange network 115 can take various forms and the exact network topology and protocols are not particularly critical. For example, the exchange network 115 can be established on the Internet, a virtual private network established via the internet or a fully private network, in each case using wired and/or wireless technology for connection and data transfer.

It will be appreciated that the proposed network, involving large scale financial transactions, will take the form of a secure, trusted network. Accordingly, although not shown in FIG. 1, appropriate firewall, data encryption and other security provisions available to protect the integrity of highly confidential data transmission and transactions will be employed at appropriate points in the system.

The various client computers are in communication with a liquidity engine computer server 110 via the exchange network 115. The liquidity engine computer is a trusted intermediary for and among the various clients participating in the system. The liquidity engine will receive and store confidential information from the various clients, such as portfolio content, client identity and the like.

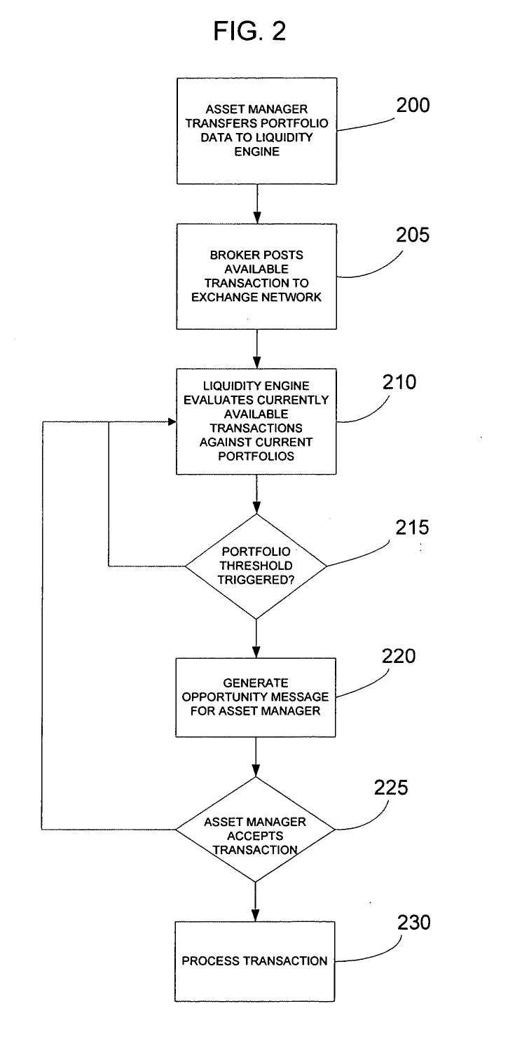

One embodiment of a method for improving securities liquidity is set forth in the flow chart of FIG. 2. The asset manager clients 100a, 100b are computers used by an asset manager to manage a portfolio of assets, such as stocks, bonds and other securities. Data representing the current portfolio for an asset manager 100a, 100b is transferred via a secure data connection to a database in the liquidity engine 110 in step 200. This operation is performed by each asset manager client that wishes to participate in the system. The exact manner in which data transfer is initiated and affected is not critical. For example, the client computer can have a graphical user interface (GUI) which directs a user of the asset manager client to transfer selected data. Alternatively, data can be bulk transferred for a number of portfolios managed by an asset manager using asset manager client computer 100a and employing an automated batch process managed by a service provided by the liquidity engine 110.

By its nature, the portfolio data is changing to reflect purchases and sales of various assets being managed in the portfolio. Therefore, updates in the portfolio data stored in the liquidity engine server 110 should take place on a sufficiently regular basis such that the portfolio data remains current. The frequency of data updates can be based on a number of factors, such as the number and size of the transactions against the portfolio as well as the total network bandwidth that is available to accommodate such data transfer.

The broker clients 105a, 105b will post orders for the transfer (purchase, sale or other transaction involving the change of ownership) of an asset such as a block of shares of a particular stock (step 205). As used herein, a broker client 105 represents any party posting an order and is not necessarily limited to a traditional broker as that term is understood in the securities industry. When a broker client posts a transfer order that represents an opportunity for liquidity of a particular asset since there is either a willing buyer or seller of that asset at the defined terms of the transfer. The posting of such block transactions is currently being facilitated by secondary exchange networks, such as the exchange network operating at the Internet domain name www.liquidnet.com. The posting of transfer orders can take place in various ways and can employ various data formats and protocols. One known protocol suitable for such postings is the Financial Information Exchange (FIX) standard. Of course, it will be appreciated that other tools for information exchange, such as XML, can be used for this process as well.

In step 210, the liquidity engine 110 evaluates the portfolio data for each of the asset manager clients 100a, 100b, against the available transfer orders posted by the broker clients 105a, 105b to determine if it would be beneficial to a portfolio to enter into the available transaction.

Various methods of portfolio analysis are known and can be employed in the present method, inclusing mean variance optimization, rank order screening or other similar methods which seek to tradeoff expected return against some combination of risk, task efficiency and implementation costs. It will be appreciated that different asset managers have different investment objectives (long term growth, short term growth, income generation, etc.) and may have different analyses performed on the respective portfolios in order to achieve the objectives of the portfolio. Regardless of the particular optimization analysis employed, various optimization thresholds can be employed in order to indicate that an available transaction may be beneficial to a portfolio and, therefore, of interest to an asset manager.

If the portfolio analysis of step 210 triggers an optimization threshold in step 215, an electronic message is generated and transmitted to the asset manager client 100a, 100b. The message will preferably inform the portfolio manager of the availability of the particular transaction, its terms and the results of the optimization analysis in which the transaction's benefits are identified. The asset manager then decides whether to accept the proposed transaction or not (step 225). If the asset manager accepts the proposed transaction, an electronic message is sent from the asset manager client computer to the liquidity engine 110 and the transaction can be completed in a manner generally known in the art (step 230). For example, the liquidity engine 110 can lock both sides into the transaction and then forward the transaction to a suitable printing service to print the transaction on tape and then notify the participants in the transaction that the transaction was completed.

The method of FIG. 2 can be further illustrated by way of example. Assume a broker client 105a wishes to trade a block of 200,000 shares of stock in XYZco. To inititiate this transaction, the broker client 105a would place a sell order on the exchange network 115. If there was an existing buy order for 200,000 shares of stock in XYZco at the terms specified, the transaction could be completed on the exchange network 115 in a conventional manner. However, if a contra position is not currently available, the liquidity engine 110 is employed to analyze the portfolio data from the asset managers 100a, 100b and determine which portfolios of assets (if any) would benefit from purchasing all or part of the 200,000 shares of XYZco being offered. If it is determined that the purchase of 200,000 shares of XYZco would benefit a portfolio of asset manager 100a, such as by providing a level of income that triggers a predefined threshold, that asset manager would be notified of the availability of these shares and provide the asset manager with the information needed to complete the decision whether to accept the transaction or not.

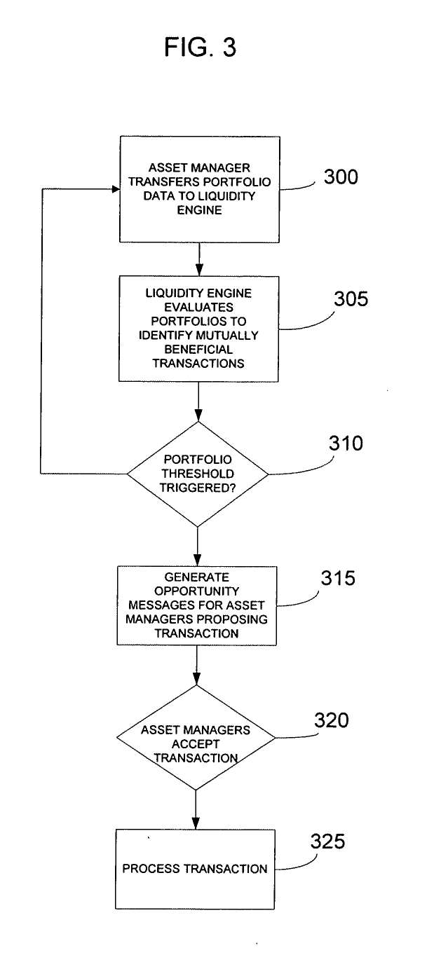

FIG. 3 illustrates an alternate method in accordance with the present invention. In step 300, the asset manager clients 100a, 100b transfer portfolio information to the liquidity engine as described above in connection with step 200. Rather than trigger portfolio analysis on the basis of an available broker posted transaction, in step 305 the liquidity engine performs portfolio analysis on two or more portfolios to identify transactions that would be mutually beneficial to the portfolios being analyzed.

If in step 310 a portfolio threshold is triggered for the portfolios being analyzed, which is an indication that a mutually beneficial transaction has been identified, the process advances to step 315 and an opportunity message can then be sent to one or both of the asset manager clients 100a, 100b identifying the proposed transaction. For example, if a transaction has been identified for an asset currently in the portfolio of asset manager client 100a and that asset would be beneficial to the portfolio of asset manager client 100b, a first message can be sent to the owner of the asset, asset manager 100a, proposing the sale of the asset and identifying the benefit of the transaction to the portfolio. If the asset manager associated with asset manager client 100a is interested in engaging in the proposed transaction, a sell order proposal can be generated by the liquidity engine and presented to the asset manager client 100b. If the asset manager associated with asset manager client 100b is interested in purchasing the asset the transaction can be accepted and processed in a manner known in the art (step 325).

Unlike the method described in FIG. 2, the alternate method illustrated in FIG. 3 does not require an initial posting of a transaction proposal from a broker client. Instead, using portfolio analysis across a number of portfolios, advantageous transactions are identified and then initiated by the present method. This further advances the liquidity of the assets by advantageously identifying and proposing optimizing transactions which may not have been identified or otherwise considered previously.

The systems and methods described herein are particularly beneficial to a network exchange in which large block transactions take place and liquidity is limited because of the size of the transaction. However, the present systems and methods are not limited to such transactions and can be applied to retail securities transactions as well. In this case, the asset manager client would be an individual stock trader who owns a portfolio of assets such as stocks. In a retail application, the exchange network can take the form of available stock trading services, such as eTrade®.

Although the present invention has been described in connection with specific exemplary embodiments, it should be understood that various changes, substitutions and alterations can be made to the disclosed embodiments without departing from the spirit and scope of the invention as set forth in the appended claims.

What is claimed is:

1. A method of improving asset liquidity by identifying a potential party to an asset transaction comprising the steps of:
receiving portfolio data from an asset manager client;
receiving transaction proposal data from a broker client;
evaluating the portfolio data in view of the transaction proposal data to determine if at least one predetermined financial threshold would be satisfied in the portfolio by accepting the proposed transaction; and
providing an alert message to the asset manager client identifying the transaction proposal if at least one predetermined financial threshold is triggered in said evaluating step.

2. The method of claim 1 wherein the transaction proposal takes the form of a block sell order for a security.

3. The method of claim 1 wherein the transaction proposal takes the form of a block buy order for a security and wherein the step of evaluating the portfolio data further comprises identifying a portfolio having the security identified in the buy order.

4. A method of improving asset liquidity by identifying potential parties to an asset transaction comprising:
receiving portfolio data from a plurality of asset manager clients;
evaluating first portfolio data and at least a second portfolio data to identify a transaction proposal wherein at least one predetermined financial threshold would be satisfied in both the first portfolio and second portfolio if the transaction proposal were accepted.
providing an alert message to at least one asset manager client identifying the transaction proposal if at least one of said predetermined financial threshold is triggered in said evaluating step.

5. The method of claim 4, wherein the alert message is sent to the asset manager client of the portfolio owning the asset of the transaction proposal and proposes a sale of the identified asset.

6. The method of claim 5, wherein if the asset manager of the portfolio owning the asset of the transaction proposal agrees to sell the asset, a second alert message is sent to the asset manager of the portfolio identified as a potential purchaser of the asset.

7. The method of claim 4, wherein the asset is a security.

8. The method of claim 7, wherein the asset is represented by a plurality of shares of a security.

9. The method of claim 8, wherein the security is stock.

10. A system for asset transactions comprising:
a data network;
a server computer operatively coupled to the data network and having a liquidity engine therein;
at least one asset manager client computer operatively coupled to said data network, each asset manager client computer providing asset portfolio data for at least one portfolio to said server computer;
at least one broker client computer operatively coupled to said data network for providing transaction proposal data to the server computer; and
wherein the liquidity engine of the server computer evaluates the portfolio data in view of the transaction proposal data to determine if at least one predetermined financial threshold would be satisfied in the portfolio by accepting the proposed transaction and provides an alert message to the asset manager client identifying the transaction proposal if at least one predetermined financial threshold is triggered in said evaluating step.

11. A system for asset transactions comprising:
a data network;
a server computer operatively coupled to the data network and having a liquidity engine therein;
a plurality of asset manager client computers operatively coupled to said data network, each asset manager client computer providing asset portfolio data for at least one portfolio to said server computer;
wherein the liquidity engine evaluates first portfolio data and at least a second portfolio data to identify a transaction proposal wherein at least one predetermined financial threshold would be satisfied in both the first portfolio and second portfolio if the transaction proposal were accepted and provides an alert message to at least one asset manager client identifying the transaction proposal if at least one of said predetermined financial threshold is triggered in said evaluating step.
